(19) United States
(12) Patent Application Publication
(10) Pub. No.: US 2008/0044028 A1
(43) Pub. Date: Feb. 21, 2008

(54) Pair-wise key pre-distribution method for wireless sensor network

(75) Inventors: Hung-Min Sun, Hsinchu (TW); Yue-Hsun Lin, Hsinchu (TW)

Correspondence Address: BUCKNAM AND ARCHER, 1077 NORTHERN BOULEVARD, ROSLYN, NY, 11576, US

(73) Assignee: National Tsing Hua University, Hsinchu (TW)

(21) Appl. No.: 11/599,962

(22) Filed: Nov. 15, 2006

(30) Foreign Application Priority Data
Jul. 25, 2006 (TW) 095127111

(51) Int. Cl. H04L 9/00

(52) U.S. Cl. 380/278

(57) ABSTRACT

The present invention provides a method regarding key deployment in wireless sensor networks, that is, with random anticipated disposition mechanism as basis, a key management mechanism is designed.

### CROSS-REFERENCES TO RELATED APPLICATIONS

The present invention provides a method regarding key deployment in wireless sensor networks, that is, with random anticipated disposition mechanism as basis, a key management mechanism is designed.

### BACKGROUND OF THE INVENTION

Under the development of hardware and wireless network technology, Wireless Sensor Networks, WSNs has already transformed into a popular technological field, however, properties of wireless sensors, as for example wireless technology enables easy monitor of data, wireless sensors itself is resource limited, many threats to security have been brought forth, including switching of data packets, monitoring, utilizing captured nodes to collect confidential information, and even further destruction of wireless networks.

Hence, security mechanism is very important towards wireless sensor networks. Moreover key management is all the more a founding stone for building up the security mechanism.

Generally speaking, key management can be roughly divided into the three following types:
(1) Trusted server as for example Kerberos.
(2) Self-enforcing as for example Diffie-hellman and RSA
(3) Key pre-distribution as for example random key pre-distribution.

And method of random key pre-distribution is suitable for use in wireless sensor networks, it possesses several of the following characteristics: use of symmetric crypto system can efficiently save energy resources, however, with key pre-deployed, great quantities of energy consumed in key build up can be saved after node deployment. Moreover without prior knowledge, the so-called prior knowledge indicates perception towards the deploying environment or position between nodes after deployment that could be predetermined. But, generally in wireless sensor networks, prior knowledge does not exists. Besides, other third party intervention is not even necessary, as for example base station interferences, these characteristics all perfectly match the characteristics of wireless sensor networks.

Nevertheless, method of random key pre-distribution was first brought up by Eschenauer and Gligor (L. Eschenauer and Virgil D. Gligor, A Key-Management Scheme for Distributed Sensor Networks,” Proc. 9^{th} ACM Conf. on Computer and Communications Security, pp. 41-47, November 2002), its method includes three steps:
(1) Key pre-distribution phase: Firstly, the base station will set up a key pool, P possessing more than k keys and corresponding relative key identity. Next, the base station will randomly select from the key pool, P, k keys not repeated, and deploy these k keys to a node, therefore, each node will separately possess k keys.
(2) Shared key discovery: To find out whether other nodes within the communication range of the node shares the same key. The simplest way is to broadcast its own key identity, nodes receiving this broadcast then compares whether it possess the same key identity too, if yes, then it represents finding the same shared key, on the contrary, then there is no similar shared key. Two nodes having discovered shared key will afterwards use this shared key to encrypt messages conveying between them.
(3) Path-key establishment: After step of discovering common key in preceding description is completed, it is possible that two nodes (Assuming as between A and B) is likely to have no common shared key between them, to enable these two nodes to securely convey messages, at this moment it is necessary to set up path key. Hence, first finding a node (Assuming as C) sharing a common key with these two nodes, utilizing keys not yet used in C as communicating bridge between A and B, which is the path key.

Chan et al. (H. Chan, A. Perrig and D. Song, “Random Key Predistribution Schemes for Sensor Networks,” Proc. IEEE Symposium on Security and Privacy, pp. 197-213, May. 2003) proclaimed improvement of Eschenauer and Gligor method, it also includes the three parts.
(1) Q-composite random key pre-distribution): This part is the way for strengthening security, basically is the method of Eschenauer and Gligor, it provided higher security under attack of minor areas. Formerly, under method of Eschenauer and Gligor, as long as there is one or more common shared key between two nodes, secure communication connections can be set up. But, in this method it is further required to necessarily have q or more common shared keys between two nodes to set up secure communication connections. After finding q shared keys, hash value made by these q shared key are used as keys needed for encryption, messages conveyed later all uses this key to encrypt and protect.
(2) Multi-path key reinforcement: This part is the re-keying scheme, also known as multi-path key reinforcement it utilizes increased communication load to strengthen security between links. As for example, assuming that node A is aware of all different secure links connecting to node B, in between it can pass through h nodes or more, without losing generality assuming A, N₁, N₂, . . . , Nₕ, B represents a path from A to B. Assuming j represents number of different secure links between A and B. Node A produces j random numerical values V₁, . . . , Vⱼ of fixed length, these random numerical values are used to generate encryption and decryption keys. Then A uses j strips of different secure links to separately convey these j number of random numerical values to B. When B receives these j number of random numerical values, the number of new link key between A and B can be calculated, calculations is as follows:

k′=k ⊕ v₁ ⊕v₂ ⊕ . . . ⊕vⱼ

Wherein k is the number of old link key, ⊕ is the Exclusive-OR (XOR) operation.

Unless the attacker cracks these j strips of secure links at the same time, else the number of new link key between A and B could never be calculated.
(3) Random pair-wise keys: The biggest difference between this part and method of Eschenauer and Gligor lies in the fact that its link key generated by any two points is unique and is impossible to have similar key generated by another pair of nodes in the network. Assuming that in sensor networks there are n nodes, the simplest way is to have every node a different shared key with other n−1 nodes, in this way there will be no similar link key, but the key storage quantity needed by this kind of method will be too large (every node needs to store n−1 keys), hence it is not suitable for use in wireless sensor networks.

Moreover, random pair-wise key does not need to store n−1 keys, however, connectivity is sacrificed in exchange for security. Through inequality of Erdos and Renyi, it can be calculated in a random graph, assuming under the given circumstance that we would want to enable the connectivity of the entire network to reach at least c, and calculate the least connectivity between two nodes, p. In a network having n nodes, to achieve least connectivity, p between two nodes, every node only needs to store np pair-wise keys.

On the contrary, if every node stores m pair-wise keys then the largest number of nodes in the network is n=m/p. In addition, due to the fact that the key stored by every node is owned by only two nodes, hence node-to-node authentication can be accomplished, only if certain key is stored in the node, when desired to authenticate if that same key is stored in its node, in this way this key can be utilized to carry out authentication protocol and confirm its legality.

Besides, Blom et al (Blom. “An optimal class of symmetric key generation systems,” Advances in Cryptology: Proc. of EURICRYPT. 84, Lecture Notes in Computer Science, pp. 471-486, 1993) using traditional cryptography as basis, proclaimed another kind of pair-wise key distribution method, wherein the biggest property lies in its λ—secure property, before λ number of nodes is captured in the entire network, other nodes not yet captured are evenly unaffected.

Before distribution, the base station will firstly construct the (λ+1)×N matrix G in the finite field GF(q), wherein N is the size of the network, matrix G is public information. Then, the base station will construct a (λ+1)×(λ+1) random symmetric matrix D in the finite field GF(q) then calculate N×(λ+1) matrix A=(D·G)^{T}, wherein (D·G)^{T} is the transpose matrix of (D·G), wherein matrix D is secret information. Due to the fact that matrix D being symmetric, we can easily derive the following result:

A·G=(D·G)^{T}·G=G^{T}·D^{T}19 G=G^{T}·D·G=(A·G)^{T}

It represents that A·G is a symmetrical matrix. Let K=A·G, hence Kᵢⱼ=Kⱼᵢ, wherein Kᵢⱼrepresents i^{th} row and j^{th} column of matrix K. They use Kᵢⱼ(or Kⱼᵢ) as pair wise key between node i and node j, because Kᵢⱼ=Kⱼᵢ. To achieve the above result, node i and node j must separately calculate Kᵢⱼ and Kⱼᵢ. Only if node k stores the information given below then it can be easily completed, wherein k=1, . . . , N:
1. Store the k^{th} row of matrix A
2. Store the k^{th} column of matrix G

Hence, if node i and node j needs to calculate the pair-wise key, they only need to exchange with each other the k^{th} column of matrix G stored by them, then Kᵢⱼ and Kⱼᵢ can be separately calculated.

Moreover, recently Du et al (W. Du, J. Deng, Y. S. Han and P. K. Varshney, “A Pair-wise Key Pre-distribution for Wireless Sensor Networks,” Proc. 10^{th} ACM Conf. Computer and Communications security, pp. 42-51, October 2003) proclaimed another kind of improved random key pre-distribution method using Blom's method as basis, it mainly extends Blom's notion to multiple spaces, previously Blom's method is single space, before node distribution, every node randomly selects τ key spaces from ω key spaces, after its distribution, if the key carried by two neighboring nodes belongs to the same space, then the pair-wise key between them could be constructed and calculated. Hence, assuming every node has its own unique ID. They settle on some secure parameters τ, ω, and λ, wherein 2≦τ<ω. The following three steps are included before key pre-distribution:
(1) Generating matrix G: Firstly, matrix elements are chosen from finite fields GF(q), wherein q is the least prime number larger than the key length used to generate (λ+1)×N matrix G Let G(j) represents the j^{th} column of matrix G and is being stored in node j. Although G(j) has (λ+1) elements, but in reality only storing the seed will do, through the seed the entire G(j) can be generated, this is the property of finite fields.
(2) Generating matrix D: ω number of symmetrical matrix D₁, . . . , Dw of size (λ+1)×(λ+1) are generated. Let Si=(Dᵢ,G), i=1, . . . ω be a key space, then matrix Aᵢ=(Dᵢ·G)^{T} can be calculated, letting τ represents j^{th} column of matrix Aᵢ.
(3) Selecting spaces τ: Every node randomly selects τ different key spaces from ω key spaces. Every Sᵢ selected by node j, node j stores Aᵢ(j), this information must be kept confidential and should not convey to other nodes as well. According to Blom's mechanism, as long as two nodes possess a common key space, they will be able to calculate the similar secret key.
(4) Key Agreement Phase: After node deployment, every node needs to explore whether it has the same key space as its neighbor node, for performing such a job, every node only needs to broadcast messages of the following three kinds of information: (a) Node ID (b) its possessed key space index (c) seed of column vector in matrix G Assuming node i and node j are neighbors, and separately receives messages broadcasted by each other as well. If they discovers that they possess shared key space, assuming it as S_{c}, then utilizing Blom's mechanism the pair-wise secret key between them can be calculated. Firstly node i possesses seeds of A_{c}(i) and G(i), node j possesses seeds of A_{c}(j) and G(j). After exchanging seed information, node i can calculate G(j), node j can calculate G(i). Then the secret key between node i and node j can be calculated Kᵢⱼ=Kⱼᵢ: Kᵢⱼ=Kⱼᵢ=A_{c}(i).G(j)=A_{c}(j).G(i).

### DESCRIPTION OF THE INVENTION

With reflection to this, the present inventor still utilizes Random Key Pre-Distribution Scheme as basis and invented a kind of pair-wise key deployment method in wireless sensors. The present invention of a kind of pair-wise key deployment method in wireless sensors is to firstly select a comparatively smaller key pool, then randomly select different combination of keys from the key pool, and deploy the class of keys to at least a node; after deploying these nodes, every node and its neighboring node will utilize the designed key agreement protocol to generate a new key.

Hence, the present invention provides a kind of pair-wise key deployment method in wireless sensors, it can enable sharing of different keys between every pair of nodes in the entire network, strengthen security, and because keys generated between every pair of node is totally different that is why attackers is unable to attack the remaining not-yet-captured nodes using information of the captured nodes. As for connectivity, the present invention of pair-wise key deployment method in wireless sensors, it can enable every node in its transmitting zone to reach complete connectivity, node and its neighbor node can both generate new keys. This kind of design in past records, every node needs to store large quantities of keys to maintain high degree of connectivity. Nevertheless, the present invention of a kind of pair-wise key deployment method in wireless sensors, not only can reduce memory requirements and at the same time maintain high degree of connectivity. In addition, the present invention of a kind of pair-wise key deployment method in wireless sensors, can all the more raise the largest number of nodes that can be deployed larger deployment flexibility. At the same time, the present invention also provides a new kind of probability model, it can be used in the calculation of average path length generated by it in the path key building step. Besides this, the present invention authenticated the accuracy of the connectivity estimation value and calculation of path length probability model through simulations.

### Detailed Description of Preferred Embodiments of the Invention

To enable personages belonging to the technology field possessing general knowledge to further comprehend the technological characteristics of the present invention, coordination of specific implementation, diagrams and tables added with detailed descriptions serves to understand the objective of the present invention, technological summaries, distinguishing feature and its accomplished efficiency better.

The present invention provides a method regarding key deployment in wireless sensor networks, it can enable sharing of different keys between every node in the entire network, raise security, and because keys generated between every pair of node is totally different that is why attackers is unable to attack the remaining not-yet-captured nodes using information of the captured nodes. Besides this, a kind of pair-wise key deployment method in wireless sensors provided by the present invention, can provide complete network connectivity and can even reduce amount of memory requirement.

### [Implementation 1]

The present invention of a kind of pair-wise key deployment method can be divided into the following three steps:
(A) Key Pre-Deployed Phase
(B) Initialization Phase
(C) Phase for adding new sensor nodes

Before describing the present invention of a kind of pair-wise key deployment method, to enable personages belonging to the technology field possessing general knowledge to clearly comprehend the specific description of the present invention, the relative code word description of the present invention are carefully stated in the following table.

TABLE 1

| Expression | Description |
|---|---|
| C″ₘ | Every possible way (combination) of choosing m objects |
| | from n objects. |
| L(n, m) | Entire combination of every possible way of choosing m |
| | objects from n objects. |
| L[k] | Key list of sensor node k, it is selected from set L(n, m). |
| L[i] | Key list of sensor node i, it is selected from set L(n, m). |
| Rᵢ | Identity key of sensor node i. |
| IDᵢ | Identity code of node i |
| \|\| | Sticky operation. |
| H(M) | Hash value of message M, H is unidirectional hash |
| | function. |
| E_{Ki}(M) | Using symmetric encryption method, Kᵢ is the key, M is |
| | the message to be encrypted, E_{Ki}(M) is the classified |
| | document after encryption. |
| S | Possible key space. |
| N | Size of the network, unit is number of nodes. |

### (A) Key Pre-Deployed Phase:

Step 1: Firstly, the base station or trusted servers will select from every possible key space, n keys. As for example, while implementing wireless sensor key deployment mechanism, if 64 bit keys are used then S=2⁶⁴. After drawing out n keys, the class of n keys is the so-called original key pool, P, in addition, an identity key pool is then drawn out, the quantity of it being greater than the deployed nodes, therefore this set is R.

Step 2: After selecting n keys, the value of m could then be calculated, the value m represents the number of keys stored by every sensor node. Wherein m is greater than half of n, as for example, when m is 10, n is 6, if m is 21 then n is 11.

Step 3: Then using combinations in principles of permutations and combinations every possibility of Cₘ^{″} is calculated, this set is L(n,m), as for example when L(10,6), then the set implies {(1,2,3,4,5,6), (1,2,3,4,5,7), (1,2,3,4,5,8), (1,2,3,4,5,9), (1,2,3,4,5,10), (1,2,3,4,6,7), (1,2,3,4,6,8), (1,2,3,4,6,9), (1,2,3,4,6,10), (1,2,3,4,7,8), (1,2,3,4,7,9), (1,2,3,4,7,10)˜(5,6,7,8,9,10)}. C(10,6) has a total of 210 key lists.

Step 4: Its every node selects an unrepeated instance from L(n,m) in advance, the sector is the key list of this node. Using node i as an example, A key list L[i]={2,5,7,8,9,10} is selected from L(10,6). Another node j also selects a key list L[j]={2,3,4,6,8,10} from L(10,6). Pay attention, L[i] will not be selected again, in other words there will be no two nodes having totally similar key list (if i≠j, then L[i]≠L[j]).

Step 5: Every node chooses the relative corresponding key based upon the key list it selected. Hence, the key list of node i, L[i]={2,5,7,8,9,10}, then keys stored in node i will be K₂, K₅, K₇, K₈, K₉, K₁₀, the set formed by these several keys is also called key ring of node i.

Step 6: Lastly, every node selects an unselected identity key from the identity key pool R. As for example, Rᵢ is the identity key of node i.

Hence, based on the method described above, the present invention of a kind of pair-wise key deployment method of wireless sensors possesses two unique characteristics:
1. Any pair of nodes shares at least a set or more keys; with regard to any two nodes, because the number of keys of two nodes adds up to 2m. In the design of the present invention, 2m>n(as m>½n). Hence, the total number of keys will be greater than the original number of keys in the key pool; besides, those 2m keys are all selected from the n keys, which represents that there will be at least one or more keys that will repeat: in other words, any two nodes shares at least a set or more keys.
2. Any pair of nodes will have at least a different key; it will definitely never be similar in its combinations. Arbitrarily drawing out two nodes from all the nodes will have at least a different key.

### (B) Initialization Phase:

When nodes are being deployed into an actual environment, it will begin work on initialization phase. Hence, when node i and node j is being deployed into the environment, node i and node j will begin set up of pair-wise keys, the course of set up is as follows:

Step 1: Calculation of Session key As represented in FIG. 1, node 1 and j will firstly broadcast its own identity and key list to neighboring nodes and both sides will receive the broadcasted message. Hence, node i will carry out sticky operations ∥ on its own identity code IDᵢ and key list L[i], and conveys it to node j through broadcast. Similarly, node j will also carry out sticky operations ∥ on its own identity code IDⱼ and key list L[j], and conveys it to node i through broadcast.

Step 2: Secure exchange of identity key. As represented in FIG. 2, when node i and j receives key list of the other party, it utilizes information in the key list to carry out comparison of its repeated parts in the key list. Hence, the key list of node i is L[i]={2,5,7,8,9,10}, the key list of node j is L[j]={2,3,4,6,8,10}, hence the overlapping parts will be 2, 8 and 10. Then, the class of nodes utilizes hash function to generate session key Kᵢⱼ between nodes. Hence, node i and j utilizes hash function H(K₂∥K₈∥K₁₀)=Kᵢⱼ. Consequently, node i utilizes this Kᵢⱼ key to encrypt its own identity key Rᵢ and identity code IDᵢ, then conveys it to node j. Node j also carries out the above described job, and identity key between each other is exchanged.

Step 3: Generation of secure link key. After node i and node j receives the classified document of each other, the two nodes utilizes Kᵢⱼ to decrypt and obtain the other party's identity key, subsequently, again utilizing sticky operations on Kᵢⱼ, Rᵢ and Rⱼ and using hash function secure link key Sᵢⱼ=H(Kᵢⱼ∥Rᵢ∥Rⱼ) between each other is formed, the secure link key Sᵢⱼ, can be used as a key to encrypt messages to be conveyed later on.

Step 4: Preserving key information. After entire secure link keys is set up between node i and node j with its neighboring nodes, node i and node j utilizes hash functions to securely preserve key information within its own V value. Hence, key list of node i is L[i]={2,5,7,8,9,10}, then its Vᵢ=H(K2∥K5∥K7∥K8∥K9∥K10). After the nodes generate the V value, it will remove the key stored previously in the key ring and only preserves its own identity key, key list and V value.

Moreover, after setting up keys, node i and node j will use Sᵢⱼ to encrypt the conveyed messages between each other.

### (C) Phase for Adding New Sensor Nodes:

Nevertheless, in wireless sensor networks, it is possible because of the following circumstances that new nodes must be added: as for example, (1) it is most possible that nodes, because of bad communications, drained electricity, or other natural factor to cause node break down. (2) For tactic changes, as for example, to change into a larger detecting environment, or adding several nodes to increase network transfer efficiency.

Above are the methods for adding nodes: node u is a new node, i is an already deployed node (old node). Firstly, before carrying out key deployment, with regard to new node u, an unrepeated sector is drawn out from set L(n,m), utilizing this sector as key list of node u. As described in step 1, node u selects a key list not yet selected from set L(10,6), assuming its selected key list as L[u]={1,4,5,7,9,10}. Following, based on the selected key list relative corresponding keys are selected and stored to new node u. Hence, key list of node u L[u]={1,4,5,7,9,10}, the difference between it and the previous step is that keys stored in u is not only m but all keys which is n keys, K₁˜K₁₀, in this way storing n keys is to ensure connectivity while new nodes are deployed to the already set up wireless sensor networks, utilizing methods of the present invention, new nodes can set up secure links with the entire already deployed nodes. Lastly, node u finds an identity key Rᵤ, not yet chosen, from the identity key pool.

Then entering steps of key deployment, its procedure is as follows:

Step 1: Sending new joining requests by newly added nodes. As represented in FIG. 3, firstly, node u broadcasts its own identity code IDᵤ and new joining request (NJR), after sticky operations, conveys them to neighboring node i.

Step 2: Exchange of identity key with new nodes (conveyed by old node to new node). As in FIG. 4, the key list L[i] of the already deployed node i, utilizes the Vᵢ generated in the previous step to encrypt its own identity key Rᵢ, and conveys it altogether to node u. If node u is a legal node then node u can decrypt and draw out the identity key Rᵢ of sensor node i.

Step 3: Exchange of identity key with new nodes (conveyed by new node to old node). As in FIG. 5, when node u receives Rᵢ, node u can utilize Rᵢ and keys carried by itself to calculate Vᵢ, then node u similarly utilizes Vᵢ to encrypt its identity key Rᵤ, and conveys it to node i. Similarly, node i must be legal so as to decrypt and retrieve Rᵤ.

Step 4: Setting up secure link key. After node i and node u utilizes the previous step to exchange each other's identity key, hash function is utilized between node i and node u to generate secure link key Sᵤᵢ between each other.

Sᵤᵢ=H(Vᵢ∥Rᵢ∥Rᵤ)

Step 5: Preserving key information. After node u sets up the entire secure links. Node u, abandons the key originally stored by it and preserves the identity key and key list and similar to the node of the previous step, node u will calculate and preserve Vᵤ, hence when key list of node u L[u]={1,4,5,7,9,10}, then Vᵤ=H(K₁∥K₄∥K₅∥K₇∥K₉∥K₁₀).

### [Implementation 2]

Another relatively better implementations of the present invention is similar to implementation 1, and is divided into the following three steps (A) Step before key deployment (B) Initialization Phase and (C) Step of adding new nodes, its relative symbols is also similar to table 1.

### (A) Step Before Key Deployment:

Step 1: Firstly, the base station or trusted servers will select from every possible key space, n keys. As for example, while implementing wireless sensor key deployment mechanism, if 64 bit keys are used then S=2⁶⁴. After drawing out n keys, the class of n keys is the so-called original key pool, in addition, an identity key pool is then drawn out, the quantity of it being greater than the deployed nodes, therefore this set is R.

Step 2: After selecting n keys, the value of m could then be calculated, the value m represents the number of keys stored by every sensor node. Wherein m is greater than half of n, as for example, when m is 10, n is 6, if m is 21 then n is 11.

Step 3: Then using combinations in principles of permutations and combinations every possibility of Cₘ^{″} is calculated, this set is L(n,m), as for example when L(10,6), then the set implies {(1,2,3,4,5,6), (1,2,3,4,5,7), (1,2,3,4,5,8), (1,2,3,4,5,9), (1,2,3,4,5,10), (1,2,3,4,6,7), (1,2,3,4,6,8), (1,2,3,4,6,9), (1,2,3,4,6,10), (1,2,3,4,7,8), (1,2,3,4,7,9), (1,2,3,4,7,10)˜(5,6,7,8,9,10)}. C₆¹⁰ has a total of 210 key lists.

Step 4: Its every node selects an unrepeated instance from L(n,m) in advance, the sector is the key list of this node. Using node i as an example, A key list L[i]={2,5,7,8,9,10} is selected from L(10,6). Another node j also selects a key list L[j]={2,3,4,6,8,10} from L(10,6). Pay attention, L[i] will not be selected again, in other words there will not be two nodes having totally similar key list

Step 5: Every node chooses the relative corresponding key based upon the key list it selected. Hence, the key list of node i, L[i]={2,5,7,8,9,10}, then keys stored in node i will be K₂, K₅, K₇, K₈, K₉, K₁₀, the set formed by these several keys is also called key ring of node i.

Hence, based on the method described above, the present invention of a kind of pair-wise key deployment method of wireless sensors possesses two unique characteristics:
1. Any pair of nodes shares at least a set or more keys; with regard to any two nodes, because the number of keys of two nodes adds up to 2m. In the design of the present invention, 2m>n(as m>½n). Hence, the total number of keys will be greater than the original number of keys in the key pool; besides, those 2m keys are all selected from the n keys, which represents that there will be at least one or more keys that will repeat: in other words, any two nodes shares at least a set or more keys.
2. Any pair of nodes will have at least a different key; it will definitely never be similar in its combinations. Arbitrarily drawing out two nodes from all the nodes will have at least a different key.

The characteristic till this part is still similar to implementation 1.

### (B) Initialization Phase:

When nodes are being deployed into an actual environment, it will begin work on initialization phase. Hence, when node i and node j is being deployed into the environment, node i and node j will begin set up of pair-wise keys, the course of set up is as follows:

Step 1: Calculation of Session key. As represented in FIG. 6, node i and j will firstly broadcast its own identity and key list to neighboring nodes and both sides will receive the broadcasted message.

Step 2: Secure exchange of identity key. As represented in FIG. 7, when node i and j receives key list of the other party, it utilizes information in the key list to carry out comparison of its repeated parts in the key list. Hence, the key list of node i is L[i]={2,5,7,8,9,10}, the key list of node j is L[j]={2,3,4,6,8,10), hence the overlapping parts will be 2,8 and 10. Then, the class of nodes utilizes hash function to generate session key Kᵢⱼ between nodes. Hence, node i and j utilizes hash function H(K₂∥K₈∥K₁₀)=Kᵢⱼ. Consequently, node i utilizes this Kᵢⱼ key to encrypt its own identity code and a time stamp Nᵢ, then conveys it to node j, when node j receives this encrypted message, decryption is carried out to retrieve Nᵢ and IDᵢ, node j also utilizes Kᵢⱼ to encrypt its own identity code IDⱼ and time stamp Nᵢ and conveys it to node i.

Step 3: Generation of secure link key. After node i and node j receives the classified document of each other, the two nodes utilizes Kᵢⱼ to decrypt and obtain the other party's identity code and time stamp, Subsequently, again utilizing IDᵢ, IDⱼ and time stamp Nᵢ and using hash function, secure link key Sᵢⱼ=HKᵢⱼ(IDᵢ∥IDⱼ∥Nᵢ) between each other is formed, the secure link key Sᵢⱼ, can be used as a key to encrypt messages to be conveyed later on.

Step 4: Preserving key information. After entire secure link keys is set up between node i and node j with its neighboring nodes, node i and node j utilizes hash functions to securely preserve key information within its own V value. Hence, key list of node i is L[i]={2,5,7,8,9,10}, then its Vᵢ=H(K₂∥K₅∥K₇∥K₈∥K₉∥K₁₀), key list of node j is L[j]={2,3,4,6,8,10}, then its Vⱼ=H(K₂∥K₃∥K₄∥K₆∥K₈∥K₁₀). After the nodes generate the V value, it will remove the key stored previously in the key ring and only preserves its own identity code, key list and V value.

### (C) Phase for Adding New Sensor Nodes:

Firstly, before carrying out key deployment, with regard to new node u, an unrepeated sector is drawn out from set L(n,m) and this node is used as key list of node u. As described in step 1, node u selects a key list not yet selected from set L(10,6), assuming its selected key list as L[u]={1,4,5,7,9,10}. Subsequently, based on the selected key list the relative corresponding keys are selected and stored into new node u. Hence, the key list of node u L[u]={1,4,5,7,9,10}, the difference between the previous step is that not only m keys are stored in node u but all the keys which is n keys, K₁˜K₁₀, in this way storing n keys is to ensure connectivity while new nodes are deployed to the already set up wireless sensor networks, utilizing methods of the present invention, new nodes can set up secure links with the entire already deployed nodes.

Then entering steps of key deployment, node i of the previous step is the old node, node u is the new node, its procedures is as follows:

Step 1: Sending new joining requests by newly added nodes. As represented in FIG. 8, firstly, node u broadcasts new joining request (NJR) message packets to all neighboring nodes including the already deployed node i.

Step 2: Exchange of identity code with new nodes (conveyed by old node to new node). As in FIG. 9, node i utilizes sticky operations and key lists along with Vᵢ generated in the preceding step as keys to encrypt its own time stamp N and identity code IDᵢ, and conveys it altogether to node u. Nevertheless, the adding of time stamp is to prevent replay attacks. Hence, if node u is a legal node, it will have the capability to decrypt and retrieve IDᵢ.

Step 3: Exchange of identity key with new nodes (conveyed by new node to old node). As in FIG. 10, when node u receives L[i], node u can utilize L[i] and keys carried by itself to calculate Vᵢ (because node u carries all the keys), then node u similarly utilizes Vᵢ to encrypt its identity code IDᵤ, merges the time stamp Nᵢ conveyed over by node i and conveys it to node i. Similarly, node i must be legal so as to decrypt and retrieve Nᵢ and IDᵤ.

Step 4: Setting up secure link key. After node i and newly added node u utilizes the previous step to exchange each other's identity code, hash function is utilized between node i and node u to generate secure link key Sᵤᵢ between each other.

Sᵤᵢ=H(Vᵢ∥IDᵢ∥IDᵤ∥Nᵢ)

Step 5: Preserving key information. After node u sets up the entire secure links. Node u, abandons the key originally stored by it and preserves the key list and similar to the node of the previous step, node u will calculate and preserve Vᵤ, hence when key list of node u L[u]={1,4,5,7,9,10}, then Vᵤ=H(K₁∥K₄∥K₅∥K₇∥K₉∥K₁₀).

Hence, the present invention of pair-wise key deployment mechanism, utilizes ways of permutations and combinations as models of key deployment, its deployed keys belongs to pair-wise code system, and the deployed and set up keys all belongs to shared keys between nodes, this type of keys possesses exclusivity, exclusivity indicates that there will not exist two pairs of similar keys, this kind of property can totally eliminate security threats brought upon by captured nodes towards other nodes. Please consult the following table, technological efficiency comparison table 2 between the present invention and background of the invention

TABLE 2

| Compared | | | | | | |
|---|---|---|---|---|---|---|
| Item | EG | CPS | DDHV | [2] | Implementation 1 | Implementation 2 |
| Security | Medium | Medium | High | High | High | High |
| against node | | | | | | |
| compromise | | | | | | |
| Node | Not | Supported | Supported | Supported | Supported | Supported |
| authentication | supported | | | | | |
| property | | | | | | |
| Key | Yes | Yes | No | Yes | Yes | Yes |
| revocation | | | | | | |
| mechanism | | | | | | |
| Connectivity | Low | Low | High | High | High | High |
| Capability of | O(n) | O(log n) | O(n²) | O(n) | O(n!) | O(n!) |
| network size | | | | | | |

[2] is the technology revealed by US20050053045.

In table 2, in accordance with the present invention and background of the invention, comparison of properties such as security against node compromise, node authentication property, key revocation mechanism, connectivity and capability of networks size are carried out. Moreover, its security against node compromise indicates the security level affecting un-captured nodes when some part of nodes are captured, and its data and keys stored in the nodes are drawn out; the present invention of pair-wise key deployment mechanism, after initialization, the nodes will definitely delete the original key, hence nodes on being captured will only affect nodes having direct link with it, the damage being extremely small. Node authentication property: indicates capable utilization of some authentication protocols to authenticate nodes. In the present invention of pair-wise key deployment mechanism, the V value of every node is used for performing node authentication. And key revocation mechanism indicates that the function of a node key can be revoked, in this part base station can be utilized to accomplish this job. In the present invention of pair-wise key deployment mechanism, the biggest benefit is that it revokes the key list and not the key list itself. Connectivity indicates a node's probability to set up node with its neighboring nodes in a randomly distributed wireless sensor networks. In the present invention of pair-wise key deployment mechanism, it can guarantee that with only two nodes within communication range, secure links can surely be set up between them. Besides, capability of network size indicates that when the node storing body is fixed and on a specific security level, the network size that can be supported key growth and security are linear or quadratic in EG, CPS, DDHV structures (n represents the capacity of the key ring). In the present invention of pair-wise key deployment mechanism, due to utilization of ways of combinations that is why it is nearly O(n!).

Besides, due to the present invention of pair-wise key deployment mechanism, its keys originally stored in the nodes after setting up links with neighboring nodes will automatically delete and further proceed to protect the key information in the original key pool. Moreover, when setting up keys, it only uses hash function for calculations, specifically uses hash function based on AES, so that considerable degree of security is provided and goal of economizing energy is reached.

Nevertheless, due to the present invention of pair-wise key deployment mechanism, it can be specifically applied in key deployment mechanisms of wireless sensor networks, it not only can securely add wireless sensor network nodes, but also possesses authentication property at the same time while setting up keys, in the entire wireless sensor networks, complete graphs can be constructed within a small range, that is why any two nodes within this range evenly possesses secure links.

Besides, the present invention of pair-wise key deployment mechanism of wireless sensor networks, because path keys are substitute plans when connectivity is not good, and the present invention can leave out the prime cost in setting up path keys, moreover it possesses properties of economizing energy, including calculation quantities, transfer quantities and storage quantities are all extremely low.

With further regard, another better implementation of the present invention can further leave out step of selecting identity key thereby drastically saving memory storage quantities, and also makes the entire previous deployment step simpler. Moreover, because it can also utilize identity code to generate session key so even if identity code experiences monitoring, if there is no key of the original key pool then it is still unable to generate session key. And because it adds time stamp in the course of key set up, enables it to possess effect that can withstand replay attacks and hence enables its security to rise drastically.

Integrating those described above, the present invention provides a pair-wise key deployment mechanism, it is specifically suited for use in key deployment between wireless sensor networks and base stations, its wireless sensor networks includes Mica, Micaz and Mote etc., Moreover in wireless network point to point transfer mode, under 802.11 architecture of wireless networks, the present invention of pair-wise key deployment mechanism can allow a single equipment or work station to directly carry out point to point data transfers, without the need of passing through wireless access point, it includes notebooks, palm tops etc. Moreover, under wired network environment, it includes Ethernet, TCP/IP network etc, personal PC and work station servers are all suitable for use.

Only those described above alone, is the better implementation of the present invention, of course it is not possible to limit the implementation boundary of the present invention based on this, moreover, modifications and changes based on the claim and contents of the summary of the present invention made by personages belonging to the technology field, possessing general knowledge, all should belong to the boundary covered by the patent of the present invention.

### BRIEF DESCRIPTION OF THE DRAWING

FIG. 1: Representing diagram of initialization step 1 of prefer implementation 1 of the present invention

FIG. 2: Representing diagram of initialization step 2 of prefer implementation 1 of the present invention

FIG. 3: Representing diagram of adding new nodes step 1 of prefer implementation 1 of the present invention

FIG. 4: Representing diagram of adding new nodes step 2 of prefer implementation 1 of the present invention

FIG. 5: Representing diagram of adding new nodes step 3 of prefer implementation 1 of the present invention

FIG. 6: Representing diagram of initialization step 1 of prefer implementation 2 of the present invention

FIG. 7: Representing diagram of initialization step 2 of prefer implementation 2 of the present invention

FIG. 8: Representing diagram of adding new nodes step 1 of prefer implementation 2 of the present invention

FIG. 9 Representing diagram of adding new nodes step 2 of prefer implementation 2 of the present invention

FIG. 10 Representing diagram of adding new nodes step 3 of prefer implementation 2 of the present invention

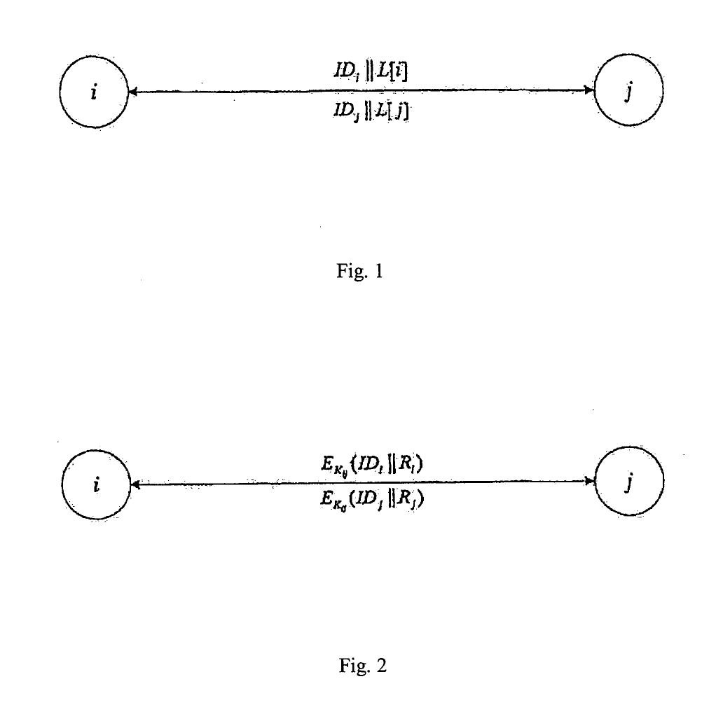

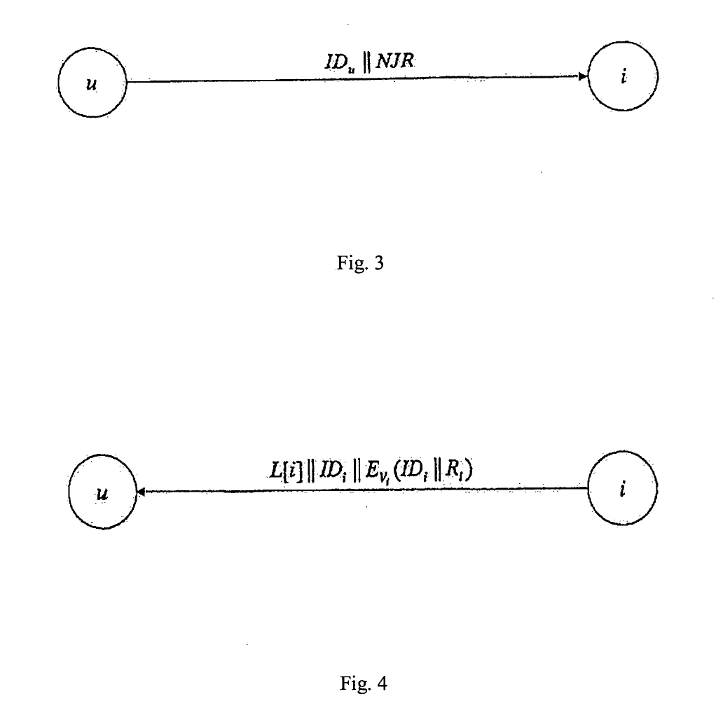

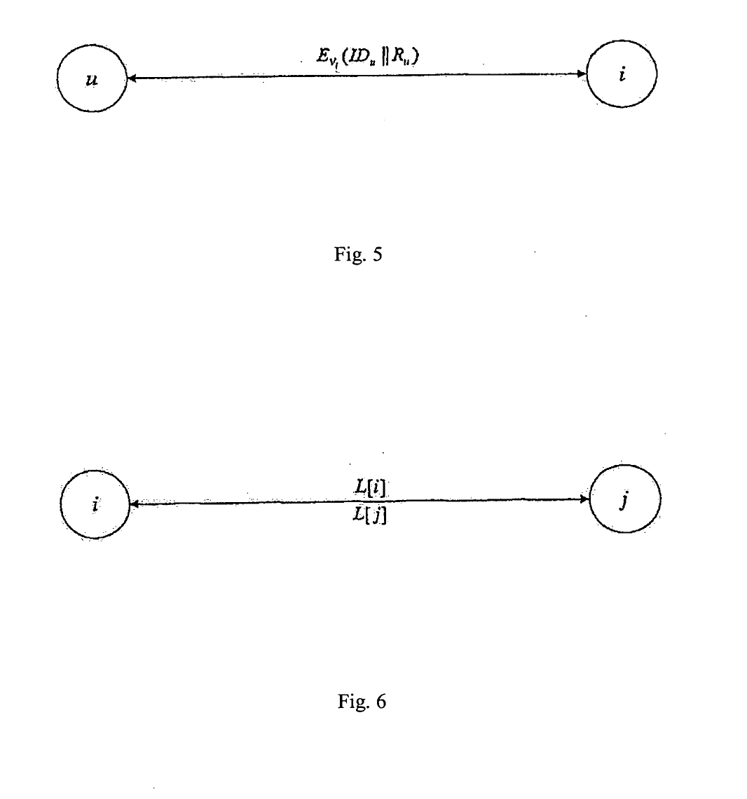

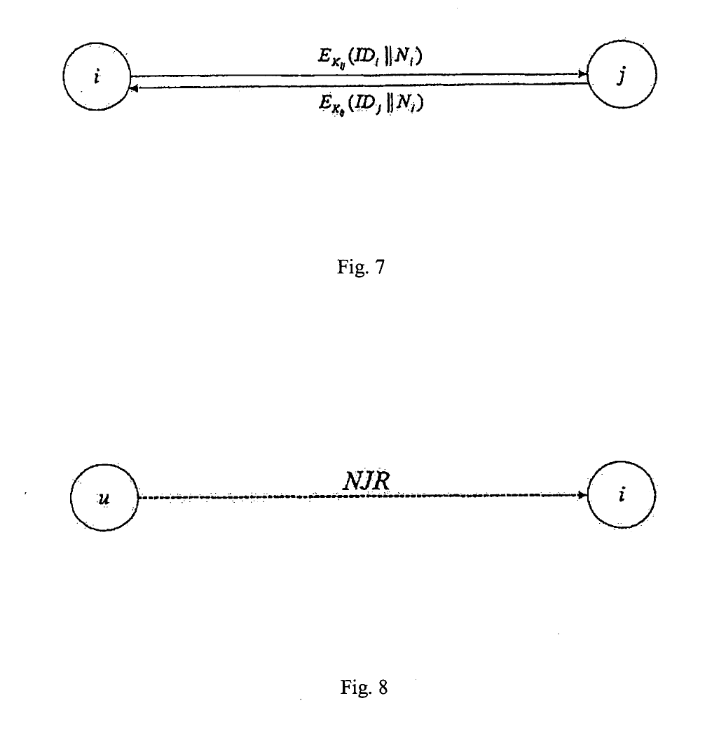

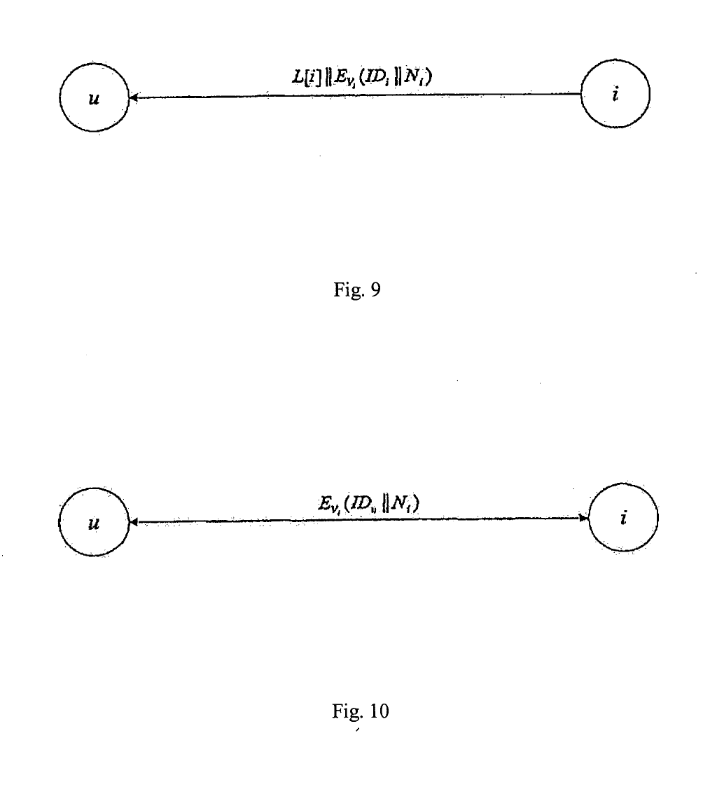

1. A method of key deployment in wireless sensor networks includes the following steps:
(a) Preceding step of key deployment: a plurality of sensor node are deployed beforehand in wireless sensor networks, and using ways of permutations and combinations, detailed key list is build up, a plurality of node separately draws out at least a sector not repeated from the key list that is built, as key list of each nodes, each node, in accordance with the key list it selected, selects the corresponding relative key so as to form a key ring, and separately stores in each sensor nodes, key rings in each sensor nodes is distributed by a predetermined way and mutually shares at least a key;
(b) Initialization step: in the wireless sensor networks deployed with plurality of sensor node, at least a sensor node is shared at least a key by at least another sensor node and mutually discovers, then secure link is set up; and
After secure link is set up in at least a sensor node with at least another sensor node, the sensor node with secure link already set up has its own distinct key information stored by a predetermined way, and the key stored in the key rings is deleted.

2. According to method of claim 1, wherein preceding step of key deployment further includes the following step: generate a key space, and randomly select the key pool in the key space, furthermore draw out another identity key pool, its sum of keys must be greater than all the amount of sensor nodes deployed.

3. According to method of claim 2, wherein the sum of keys stored by every sensor node must be greater than half of the sum of keys randomly selected from key space.

4. According to method of claim 3, wherein further includes the following step: from the sum of keys randomly selected from the key space and the amount of keys stored in every sensor node, utilizing ways of permutations and combinations to calculate its possibility to combine hence to use it to build up the detailed key list.

5. According to method of claim 4, wherein further includes the following step: a plurality of sensor node deployed in wireless sensor networks separately draws out mutually non repeated sectors from the key list that is build, key list between sensor nodes is not entirely similar.

6. According to method of claim 4, wherein further includes the following step: every sensor node separately selects from the identity key pool, an identity key not yet chosen, as identity key for sensor node itself.

7. According to method of claim 1, wherein further includes the following step during initialization step: at least a sensor node with another sensor node will in accordance with the key it chose and stored carry out pair-wise key set up, at least a key is shared mutually between sensor nodes, discovers and carries out linking.

8. According to method of claim 7, wherein further includes the following step: at least a sensor node carries out sticky operations on the identity code and the key list stored by itself and through broadcast is conveyed to at least another sensor node, and at least another sensor node will also carry out sticky operations on the identity code and the key list stored by itself and through broadcast is conveyed to at least another sensor node and both mutually conveys.

9. According to method of claim 8, wherein further includes the following step: after receiving the sticky operations broadcast of the identity code and the key list between sensor nodes, the sensor nodes will then make use of the key list information stored by it self to carry out comparison and to find out the repeated key part, and utilizing hash function, combinations is carried out on the class of repeated key parts which forms session keys, identity keys and identity codes of the sensor nodes are encrypted by the session keys and are conveyed between sensor nodes.

10. According to method of claim 9, wherein further includes the following step: at least a sensor node and at least another sensor node after receiving messages encrypted by session keys, utilizing session keys formed by itself, decryption is done and identity key and identity code of the opposite sensor node is acquired, again using hash function, secure link key is formed mutually between the session key, identity key between sensor nodes.

11. According to method of claim 10, wherein secure link key can be used as encryption keys for messages transfer between sensor nodes.

12. According to method of claim 10, wherein further includes the following step: when plurality of sensor nodes deployed in wireless sensor networks have completed the building of entire secure link keys, sensor nodes then utilizes hash function to combine the identity key and key list of itself to form v value, keys existing in key rings are then removed.

13. A method of key deployment in wireless sensor networks, is the utilization of the wireless sensor networks deployed by the method as claimed in claim 12 to add at least a new sensor node, it includes the following step:
(a) Preceding step of key deployment: the at least new sensor node separately draws out at least a non repeated sector as the key list of the class of new sensor nodes from the detailed key list build up by ways of permutations and combinations, and selects a identity key not yet selected from the identity key pool, furthermore based on the key list to select the corresponding key to form key rings, and then store all the keys chosen randomly from the key space.
(b) Step of key deployment: at least a new sensor node is shared at least a key by at least a sensor node already deployed and mutually discovers then sets up secure link; and after secure link is set up by at least a sensor node and at least a sensor node already deployed, the class of sensor nodes with secure link already set up uses a predetermined storing its individual key information and deletes the key stored by it in the key ring.

14. According to method of claim 13, wherein further include the following step: at least a newly added node separately convey its own identity key and newly added request to at least a sensor node already deployed; at least a sensor node already deployed then uses its own key list and identity code and utilizes its v value to encrypt its own identity key and identity code, and conveys it altogether to at least a newly added sensor node.

15. According to method of claim 14, wherein further includes the following step: at least a newly added sensor node after receiving identity code and key list, then uses the key list information stored by itself to carry out comparison, and to find out its repeated parts, and utilizing hash function to carry out combinations on the class of repeated key parts to form session keys, decryption is carried out on the session keys to obtain the identity key of at least a sensor node already deployed.

16. According to method of claim 14, wherein at least a newly added sensor node uses the identity key derived from at least a sensor node already deployed and the key carried by at least a newly added sensor node itself to calculate its v value, then utilizing the v value encryption is carried out on the identity code and identity key of at least a newly added sensor node, and conveys to the identity key of at least a sensor node already deployed, so as to enable exchange of identity keys between sensor nodes.

17. According to method of claim 16, wherein between at least a sensor node already deployed and at least a newly added sensor node, using hash function, mutual secure link key are formed from v value, identity key of at least a sensor node already deployed and identity key of at least a newly added sensor node.

18. According to method of claim 17, wherein further include the following step: as entire secure link keys have finished set up between at least a newly added sensor node deployed in wireless sensor networks and at least a sensor node already deployed, at least a newly added sensor node then utilizes hash function to combine its own identity key, key list to form v value and its originally stored key is then removed.

19. A method of key deployment in wireless sensor networks, wherein a time stamp can be added selectively in method as claimed in claim 1.

20. According to method of claim 19, wherein during initialization step, wherein at least a sensor node conveys the key list stored by it to at least another sensor node through broadcasts, and at least another sensor node also conveys the key list stored by itself to at least a sensor node through broadcasts and mutually conveys.

21. According to method of claim 20, wherein further include the following step: after receiving broadcast of key list between sensor nodes, sensor nodes then utilizes key information stored by itself to carry out comparison, and to find out its repeated key parts, and utilizing hash function combination is carried out on the class of repeated key parts to form session keys, using the session keys identity code and time stamp are encrypted and conveyed between sensor nodes.

22. According to method of claim 21, wherein further include the following step: at least a sensor node and at least another sensor node after receiving messages encrypted by session keys utilizes session keys formed by itself to decrypt and acquire identity code and time stamp of the opposite sensor node, again using hash function, mutual secure link key are formed from identity code and time stamp of the sensor node.

23. According to method of claim 21, wherein further include the following step: its secure link key can be used as encrypting keys for conveying messages between sensor nodes.

24. According to method of claim 21, wherein further include the following step: after entire secure link keys between a plurality of sensor nodes deployed in wireless sensor networks have finished set up, the sensor node then utilizes hash function to combine the identity code, key list of its own to form v value and keys existing in key rings are then removed.

25. A method of key deployment in wireless sensor networks, is adding at least a new sensor node by utilizing wireless networks deployed by the method as claimed in claim 18, wherein during step of key deployment, at least a newly added sensor node broadcast newly added request to at least a sensor node already deployed, the at least a sensor node already deployed then utilizes sticky operations on key list and v value generated in the preceding step to encrypt its own time stamp and identity code, and conveys it altogether to at least a newly added sensor node;
At least a newly added sensor node after receiving key list then utilizes key information stored by it self to carry out comparison, and to find out its repeated key part, and utilizing hash function to carry out combinations on the class of repeated key parts to form session keys, decryption is carried out on the session keys to obtain the identity code and time stamp of at least a sensor node already deployed.
At least a newly added sensor node then utilizes the key list derived from at least a sensor node already deployed and the key carried by at least a newly added sensor node itself to calculate its v value, then utilizing the v value encryption is carried out on the identity code of at least a newly added sensor node and time stamp of at least a sensor node already deployed, and conveys to at least a sensor node already deployed, so as to enable exchange of identity codes between sensor nodes, again using hash function, mutual secure link key are formed from v value, identity code of at least a newly added sensor node, identity code of at least a sensor node already deployed and time stamp of at least a sensor node already deployed;
As entire secure link keys have finished set up between at least a newly added sensor node and at least a sensor node already deployed, in wireless sensor networks, at least a newly added sensor node then utilizes hash function to combine key list to form v value and its originally stored key is then removed.

26. A wireless sensor network system, is utilizing method of key deployment in wireless sensor network as claimed in claim 1, and accomplished by deployment of wireless sensor network nodes.

27. According to method of claim 15, wherein at least a newly added sensor node uses the identity key derived from at least a sensor node already deployed and the key carried by at least a newly added sensor node itself to calculate its v value, then utilizing the v value encryption is carried out on the identity code and identity key of at least a newly added sensor node, and conveys to the identity key of at least a sensor node already deployed, so as to enable exchange of identity keys between sensor nodes.
